(19) United States
(12) Patent Application Publication
(10) Pub. No.: US 2026/0160102 A1
(43) Pub. Date: Jun. 11, 2026

(54) Adjustment device for a pivotable vehicle flap

(71) Applicant: Edscha Engineering GmbH, Remscheid (DE)

(72) Inventors: Jorg DORNEN, Remscheid (DE); Peter Mrowka, Remscheid (DE); Jochen Bals, Remscheid (DE); Ervin Jahic, Remscheid (DE)

(21) Appl. No.: 18/706,458

(22) PCT Filed: Sep. 8, 2022
(86) PCT No.: PCT/DE2022/100664

§ 371 Date: May 1, 2024

(30) Foreign Application Priority Data
Nov. 2, 2021 (DE) 102021128511.9

(51) Int. Cl. E05F 1/10

(52) U.S. Cl. CPC E05F 1/1058; E05Y 2600/502; E05Y 2600/622

(57) ABSTRACT

An adjustment device for a pivotable vehicle flap includes a housing which includes a first housing part and a second housing part, and a pretensioning part arranged in the housing and extending along a longitudinal axis for pretensioning the first housing part relative to the second housing part. The adjustment device also includes a first connection element arranged at a first end of the housing for connecting to one of the vehicle body and the vehicle flap, and a second connection element arranged at a second end of the housing for connecting to the other of the vehicle body and the vehicle flap. A first securing element axially secures the first connection element to the housing, and the first securing element has a securing portion which is coupled to the housing. The securing portion includes a first securing collar which is connected to an inner side of the housing.

The present disclosure relates to an adjustment device, in particular for a vehicle flap arranged pivotably on a vehicle body, according to the preamble of claim 1.

### BACKGROUND

In practice, adjustment devices, in particular suspension struts, are known which are arranged between two components which can be moved relative to one another, in particular a pivotable vehicle flap and a vehicle body, wherein the adjustment devices each comprise at least one first connection element for connecting the adjustment device to the vehicle flap and a second connection element for connecting the adjustment device to the vehicle body.

DE 10 2007 035 078 A1 shows an adjustment device comprising a telescopic housing with a first housing part and a second housing part guided displaceably in the first housing part. Furthermore, the known adjustment device comprises a piston-cylinder assembly arranged in the housing, which piston-cylinder assembly is designed as a gas spring. The gas spring comprises a cylinder which is filled with a fluid and a piston rod which is guided out of a first end of the cylinder in a fluid-tight manner and can be extended and retracted. Furthermore, the adjustment device comprises a first annular disk which has an opening through which the piston rod is guided. The first annular disk is screwed onto or integrally connected to the first housing part. The free end of the piston rod is connected by a screw connection to a first connection element designed as a ball socket, so that the adjustment device can be connected in an articulated manner to one of the vehicle flap and the vehicle body. A pin is arranged at a second end of the cylinder opposite the first end, which pin has an external thread, over which a second annular disk is pushed and an adapter element with an internal thread is screwed, as a result of which the second annular disk is fixed on the pin. The adapter element also has a pin having an external thread, on which a second connection element designed as a ball socket is fastened, so that the second connection element is connected to the gas spring and the adjustment device can be connected in an articulated manner to the other of the vehicle flap and the vehicle body. The pin of the adapter element is guided through an opening in the end of the second housing part that is closed by a bottom piece. A disadvantage of the known adjustment device is that the connection between the gas spring, or the connection elements fixed to the gas spring by screwing, and the housing part is only realized for housings with closed ends or existing bottom pieces, which limits the selection of possible housing designs for fastening connection elements.

DE 10 2019 128 684 A1 shows an adjustment device for a pivotable vehicle flap, comprising a housing with a first housing part and a second housing part, which are telescopically movable relative to one another, wherein the first housing part is prestressed relative to the second housing part by means of a pretensioning means arranged in the housing. The adjustment device further comprises a first connection element arranged at a first end of the housing and designed as a ball socket for connecting to one of the vehicle body and the vehicle flap and a second connection element arranged at a second end of the housing for connecting to the other of the vehicle body and the vehicle flap. A connecting element is arranged between the housing and the first connection element, wherein the first connection element is axially secured to the housing by the connecting element.

DE 10 2018 117 889 A1 shows an adjustment device for a pivotable vehicle flap, comprising a housing with a first housing part and a second housing part, wherein the first housing part are prestressed against one another relative to the second housing part by means of a pretensioning means arranged in the housing. Furthermore, the adjustment device comprises a first connection element arranged at a first end of the housing and a second connection element arranged at a second end of the housing. The first connection element is screwed to a guide tube arranged in the housing, wherein the housing is closed at the first end by a cover element. The cover element is thereby arranged radially between a connecting portion of the first connection element and the housing.

### SUMMARY

It is an object of the present disclosure to provide an adjustment device which is designed to be cost-effective, flexible and reliable.

According to one aspect of the present disclosure, an adjustment device is created, in particular for a pivotable vehicle flap, comprising a housing, wherein the housing comprises a first housing part and a second housing part. The adjustment device further comprises a pretensioning means arranged in the housing and extending along a longitudinal axis for pretensioning the first housing part relative to the second housing part, a first connection element arranged at a first end of the housing for connecting to one of the vehicle body and the vehicle flap, and a second connection element arranged at a second end of the housing for connecting to the other of the vehicle body and the vehicle flap, wherein a first securing element is arranged between the first connection element and the housing, wherein the first securing element axially secures the first connection element to the housing. Furthermore, the first securing element has a securing portion which is coupled to the housing. Advantageously, this ensures that a connection securing the connection element to the housing is established by the securing element. The adjustment device according to the present disclosure is characterized in that the securing portion comprises a first securing collar which is at least non-positively connected to an inner side of the housing. Advantageously, the securing element can be easily mounted between the first connection element and the housing by inserting without the need for material-bonded connection types, such as adhesion or welding. Further advantageously, the securing element can be removed and replaced again if necessary, without any impairment or even damage of the housing or of the connection element to be connected to the housing thereby taking place. In the adjustment device according to the present disclosure, it is accordingly advantageously not necessary to firmly connect the first connection element to an end of the housing, for example by welding or gluing. These connection methods disadvantageously result in the connection element no longer being removable from the housing without destruction when the connection element has to be replaced. Furthermore, housings or housing parts that are designed as simple open hollow cylinders and do not have to have end-side bottom elements or closed ends with a bore can also advantageously be used, since the securing of the first connection element to the housing is ensured in any case separately by the use of the first securing element.

In an expedient development, it is provided that the first securing element has an inner collar which is coupled to the first connection element. Advantageously, this makes it possible for a reliable connection between the first securing element and the connection element to be established simply by forcing or pressing the inner collar onto an extension provided on the first connection element or by pressing onto an end face of the first connection element. Advantageously, a structural unit of the connection element and securing element can thus be produced in a simple manner, which unit can be secured in the housing simply by insertion into the housing.

Particularly preferably, the securing portion is self-securing. Advantageously, the securing of the first securing element and thus of the first connection element, coupled via the inner collar, in the housing can take place without the use of additional securing means such as adhesives or welding points, in that the structural unit consisting of the first securing element and the first connection element is pressed into the housing and thereby is securely held in the housing due to the self-securing securing portion of the first securing element.

Alternatively or additionally, it can be provided that the securing portion is connected or can be connected to an inner side of the housing in a positive-locking manner. For this purpose, the inner side of the housing preferably has a recess, into which the first securing collar provided in the securing portion can latch and thus an additional axial securing is provided by a positive connection between the first securing element and the housing. Further advantageously, the axial position of the first securing element within the housing is fixed in a defined manner, so that the first securing element cannot slip relative to the housing during ongoing operation of the adjustment device.

Particularly preferably, the securing collar comprises at least two prongs separated by a slot. Advantageously, the securing collar is thereby designed to be elastically more bendable, so that a sufficient holding force of the first securing element is produced in the housing, in that prongs of the securing collar separated by the slot are brought into contact with an inner side of the housing through elastic bending and thus a sufficient frictional force, in particular a clamping between the first securing element and the housing, is provided.

Preferably, the securing collar comprises multiple slots, which face the housing, or multiple prongs separated by slots, which prongs are elastically bendable. Advantageously, a sufficiently high clamping force of the first securing element on the housing can thus be achieved, so that the first securing element and the first connection element are held securely on the housing during ongoing operation of the adjustment device under the axial force generated by the pretensioning means.

In an advantageous development, it is provided that the first securing element has an intermediate portion, wherein the intermediate portion is arranged radially between the inner collar and the securing portion. Advantageously, the intermediate portion allows a radial and possibly also an axial distance between the inner collar and the securing portion to be bridged. Further advantageously, geometric conditions prevailing in the housing can be flexibly taken into account by corresponding design of the intermediate portion.

In a preferred embodiment, the first securing element consists of metal, in particular a spring steel strip. Advantageously, the securing portion and the inner collar of the first securing element are, on the one hand, in particular elastically bendable and, on the other hand, are designed to be sufficiently flexurally rigid that the first securing element can be fastened with a high holding force, in particular by clamping in the housing or on the first connection element.

In a first development, the first securing element is designed as a securing plate. The inner collar of the securing plate preferably has a flat end face. The flat end face is advantageously suitable for being pressed against an end face of the first connection element, for example by clamping the inner collar between the end face of the first connection element and one end of the pretensioning means, which comprises a stop surface.

In a further preferred embodiment, the first securing element is designed as a securing disk. Advantageously, the inner collar of the first securing element has multiple prongs separated by slots, which prongs are directed inwards. Advantageously, the first securing element can thereby be fastened simply by pressing on an inner extension provided on the first connection element, so that the first connection element can be connected to the housing together with the first securing element thus fastened. Equally, however, it is also possible to first connect the first connection element provisionally attached to the housing to one end of the pretensioning means and then to secure the first connection element to the housing by pressing the inner collar and the prongs arranged thereon onto an extension of the first connection element. The securing portion of the first securing element preferably also has prongs separated by slots, which prongs are directed outward in order to be able to perform the securing of the first connection element to the housing in a single working step.

A second securing element is particularly preferably arranged between the second connection element and the housing, wherein the second securing element axially secures the second connection element to the housing. Advantageously, both the first housing part and the second housing part can be designed as a simple hollow cylinder, at each end of which a connection element can be simply and securely fastened by means of a securing element. The second securing element is expediently designed as a securing plate or as a securing disk.

In an expedient embodiment, it is provided that the first connection element is connected to a first end of the pretensioning means, and the second connection element is connected to a second end of the pretensioning means. Particularly preferably, the first connection element is connected to the first end of the pretensioning means by a screw connection. Further advantageously, the second connection element is connected to the second end of the pretensioning means by a screw connection. Advantageously, a simple and nevertheless secure connection between the first connection element or the second connection element is produced to the pretensioning means, so that axial forces provided by the pretensioning means are reliably transmitted to the connection elements.

In an advantageous development, the inner collar of the first securing element is fixed in a clamped manner between a flat end-face stop surface provided at a first end of the pretensioning means and an end face of the first connection element. Alternatively, it is provided that the first securing element is fixed in a clamped manner radially between the first connection element and the housing.

Advantageously, the first securing element can be fixed either by a screw connection of the first connection element to the first end of the pretensioning means by axially clamping the inner collar between the first end of the pretensioning means and the first connection element or by radially clamping the inner collar or the first securing element between the first connection element and the housing, i.e. by pressing the first securing element between the first connection element and the housing.

Further advantages, properties, and developments of the present disclosure emerge from the following description of a preferred exemplary embodiment and from the dependent claims.

### BRIEF SUMMARY OF THE DRAWINGS

The present disclosure will now be explained in more detail with reference to the accompanying drawings using a preferred exemplary embodiment.

FIG. 1 shows a preferred exemplary embodiment of an adjustment device in a cross-sectional view.

FIG. 2 shows a detailed view in the region of the first connection element 5.

FIG. 3 shows a detailed view in the region of the second connection element 6.

FIG. 4 shows a perspective view of the first securing element 13 from FIG. 2.

FIG. 5 shows a perspective view of the second securing element 20 from FIG. 3.

### DETAILED DESCRIPTION

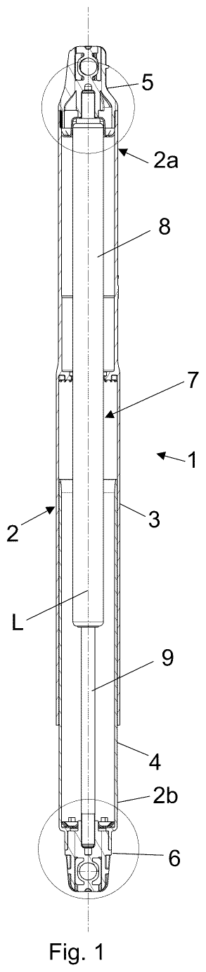

FIG. 1 shows a preferred exemplary embodiment of an adjustment device 1 in a cross-sectional view. The adjustment device 1 is designed as a suspension strut and comprises a telescopic housing 2, comprising a first housing part 3 and a second housing part 4 guided axially displaceably in the first housing part 3.

A first connection element 5 is arranged at a first end 2a of the housing 2, wherein the first connection element 5 is designed as a ball socket. Advantageously, the first end 2a of the telescopic housing 2 can be connected in an articulated manner to one of the vehicle flap and the vehicle body by the first connection element 5. A second connection element 6 is arranged at an end 2b opposite the first end 2a of the housing 2, wherein the second connection element 6 is designed as a ball socket. Advantageously, the second end 2b of the housing 2 can be connected in an articulated manner to the other of the vehicle flap and the vehicle body by the second connection element 6.

A pretensioning means 7 designed as a gas spring is arranged in the hollow cylindrical housing 2 and comprises a cylinder 8 filled with fluid and a piston rod 9 protruding from the cylinder 8 and displaceable axially in the cylinder 8. The gas spring 7 extends along a longitudinal axis L and prestresses the first housing part 3 and the second housing part 4 relative to one another, so that, when the gas spring 7 is activated, an axial displacement of the first housing part 3 relative to the second housing part 4 takes place with a change of the total length of the housing 2. As a result, the distance of the first connection element 5 relative to the second connection element 6 is changed accordingly, so that an adjustment, in particular a pivoting of a vehicle flap connected to the adjustment device 1, relative to a vehicle body can take place.

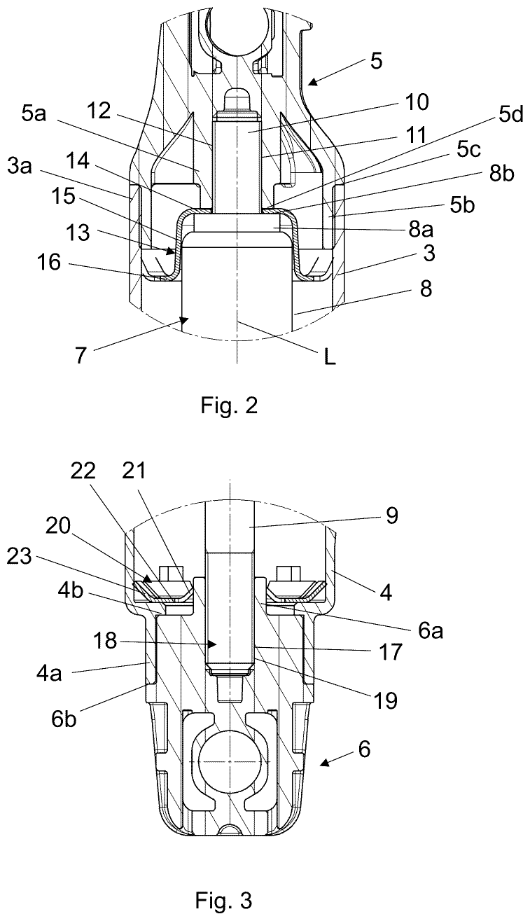

FIG. 2 shows a detailed view in a region of the first connection element 5, which is marked in FIG. 1 by means of the circular marking shown there. It can be seen in this view that a pin-shaped first extension 10 is arranged at a first end 8a of the cylinder 8, which end faces the first connection element 5. The extension 10 has an external thread 11. The first connection element 5 designed as a ball socket has an inner hollow cylinder portion 5a and an outer hollow cylinder portion 5b.

The inner hollow cylinder portion 5a has an internal thread 12 which meshes with the external thread 11 of the first connection element 5. Advantageously, the first connection element 5 is securely connected to the gas spring 7 by a screw connection. This ensures that, when the gas spring 7 is activated, a force is transmitted to the first connection element 5, which leads to a movement of the vehicle flap and/or assists this movement. At its upper end, the outer hollow cylinder portion 5b has a step 5c which is supported on an end portion 3a of the first housing part 3, which end portion faces the first connection element 5. Advantageously, this makes it possible to precisely fix the axial position of the first connection element 5 on the first housing part 3, as explained in more detail below.

Furthermore, a first securing element 13 is arranged at the first end 8a of the cylinder 8. The first securing element 13 serves to secure the first connection element 5 to the first housing part 3. The first securing element 13 is advantageously designed as a securing plate which is produced from a spring steel strip. Advantageously, the securing element 13 can be produced cost-effectively in large quantities. The first securing element 13 has a radially inwardly curved inner collar 14. An intermediate portion 15 extending along the longitudinal axis L of the gas spring 7 adjoins the inner collar 14.

A securing portion 16 is arranged opposite the inner collar 14, wherein the intermediate portion 15 is arranged between the inner collar 14 and the securing portion 16 and connects them to one another. The securing portion 16 serves to secure the first securing element 13 and thus the first connection element 5 and the gas spring 7 in the housing 2 or the first housing part 3. For this purpose, the securing portion 16 is outwardly curved in the direction toward the inner wall of the first housing part 3, so that at least one non-positive connection exists between the first securing element 13 and the first housing part 3.

The inner collar 14 of the first securing element 13 is axially fixed between an end face 5d of the inner hollow cylinder portion 5a of the first connection element 5 and the first end 8a of the cylinder 8. For this purpose, the first end 8a of the cylinder 8 has a flat end-face stop surface 8b against which the inner collar 14 of the first securing element 13 is prestressed onto the first extension 10 by the screw connection of the inner hollow cylinder portion 5a. Advantageously, the first securing element 13 is thereby connected to the gas spring 7 in a non-rotating and stationary manner, so that the first connection element 5, the gas spring 7 and the first securing element 13 form a structural unit which can be installed in the first housing part 3.

For mounting the first connection element 5 to the first housing part 3, first the first securing element 13 is attached or screwed onto the first extension 10 of the cylinder 8 and then the first connection element 5 is screwed onto the first extension 10, so that the inner collar 14 is fixed in a clamped manner between the stop surface 8b and the end face 5d, and thus the first connection element 5, the first securing element 13 and the gas spring 7 form a structural unit. Finally, the first housing part 3 is placed over the gas spring from below 7 until the end portion 3a of the first housing part 3 strikes the step 5c of the first connection element 5. Due to the contact with the first housing part 3, the securing portion 16 is thereby bent inwards and thereby generates a clamping connection between the first securing element 13 and the first housing part 3, so that the first connection element 5 is axially secured in the first housing part 3 by the first securing element 13.

FIG. 3 shows a detailed view in a region of the second connection element 6, which is marked in FIG. 1 by means of the circular marking shown there. At its free end, the piston rod 9 of the gas spring 7 shown in FIG. 1 has an external thread 17 which is provided to connect the second connection element 6 designed as a ball socket to the piston rod 9. The second connection element 6 has an inner hollow cylinder portion 6a, which is a continuation of a bore 18 provided in the second connection element 6. An internal thread 19, which meshes with the external thread 17 of the piston rod 9, is arranged in the bore 18 or the inner hollow cylinder portion 6a, so that the second connection element 16 designed as a ball socket is thereby fixedly connected to the piston rod 9.

The second connection element 6 has a step 6b on the outside, which step is supported on an end portion 4a of the second housing part 4, which end portion faces the second connection element 6. Advantageously, the axial position of the second connection element 6 on the second housing part 4 is thereby precisely fixed. The end portion 4a is hollow-cylindrical, wherein the inner hollow cylinder portion 6a of the second connection element 6 is inserted into the end portion 4a of the second housing part 4. In addition, the end portion 4a has an inwardly projecting step 4b, against which the first connection element 6 is supported and thus also advantageously allows precise positioning of the second connection element 6 on the second housing part 4.

A second securing element 20 is arranged on the inner hollow cylinder portion 6a of the second connection element 6. The second securing element 20 comprises an upwardly curved inner collar 21, a flat intermediate portion 22 and an upwardly curved securing portion 23 which serves to secure the second securing element 20 in the housing 2 or the second housing part 4. The inner collar 21 radially surrounds one end of the inner hollow cylinder portion 6a, wherein a non-positive connection between the second connection element 6 and the housing 2 or the second housing part 4 is established by the clamping of the second securing element 20 between the inner hollow cylinder portion 6a and the second housing part 4. Both the inner collar 21 and the securing portion 23 are upwardly curved, so that the flat intermediate portion 22 can advantageously rest on the inwardly projecting step 4b of the second housing part 4 and thus a well-defined position of the second securing element 20 relative to the second connection element 6 is present.

For mounting the second connection element 6, the second securing element 20 is first pressed into the second housing part 4 until the intermediate portion 22 rests against the inwardly projecting step 4b of the second housing part 4.

The second housing part 4 is then completely inserted into the first housing part 3 (see FIG. 2), so that the second connection element 6 can be screwed onto the piston rod 9.

Finally, the second housing part 4 is pulled out of the first housing part 3 again, so that the inner collar 21 is pressed onto the inner hollow cylinder portion 6a of the second connection element 6 and the second connection element 6 is thereby axially secured relative to the second housing part 4 by the second securing element 20.

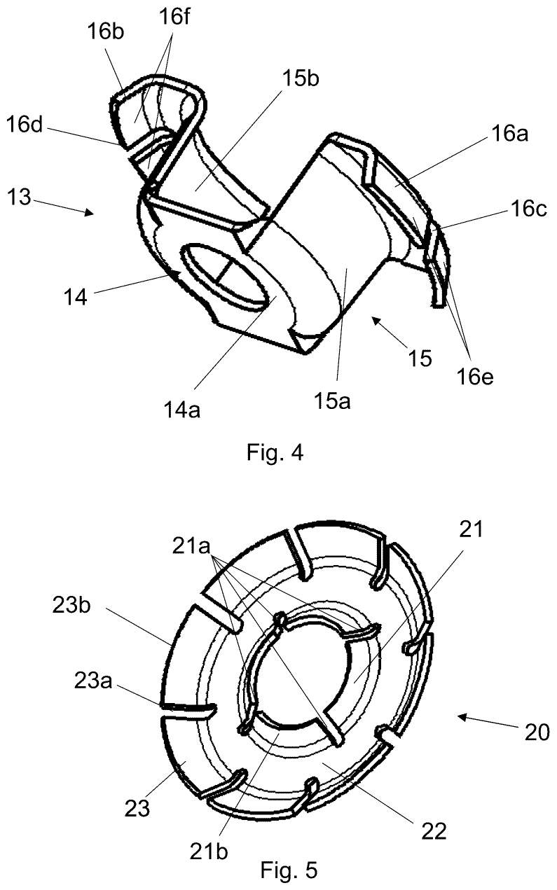

FIG. 4 is a perspective view of the first securing element 13 from FIG. 2. The inner collar 14 is annular and has a flat end face 14a which, in the installed state, rests against the end face 5d, shown in FIG. 2, of the inner hollow cylinder portion 5a. The intermediate portion 15 comprises a first partial cylinder portion 15a and a second partial cylinder portion 15b opposite the first partial cylinder portion 15a. The securing portion 16 comprises a first securing collar 16a which projects radially outward from the first partial cylinder portion 15a. Furthermore, the securing portion 16 comprises a second securing collar 16b which projects radially outward from the second partial cylinder portion 15b.

The first securing collar 16a and the second securing collar 16b each have a slot 16c, 16d, each of which separates two prongs 16e, 16f, which are each used for the first securing collar 16a and the second securing collar 16b to be elastically bendable. Advantageously, the first securing collar 16a and the second securing collar 16b bring about a clamping force acting radially outward, so that when the first securing element 13 is clamped radially between the gas spring 7 and the first housing part 3 (see FIG. 2), a holding force is provided which leads to a securing of the first securing element 13 and the gas spring 7 connected to the first securing element 13 by the screw connection and the first connection element 5 to the first housing part 3. Advantageously, complex welding of the first connection element 5 to the first housing part 3 is not necessary, wherein a replacement of the first connection element 5 is possible without any greater effort and without damage to the first housing part 3. In the installed state and during normal operation, the holding force provided by the first securing element 13 is large enough that the first stop element 5 is securely fastened in the first housing part 3.

FIG. 5 is a perspective view of the second securing element 20 from FIG. 2. The second securing element 20 is designed as a securing disk and comprises an inner collar 21 provided with multiple slots 21a, an annular intermediate portion 22, and a securing portion 23 which protrudes radially outwards as a securing collar with multiple slots 23a. The slots 21a on the inner collar 21 separate elastically bendable inner prongs 21b, and the slots 23a in the securing portion 23 separate elastically bendable outer prongs 23b, which cause the inner collar 21 or the securing collar 23 to be elastically bendable overall, so that when the second securing element 20 is clamped between the inner hollow cylinder portion 6a of the second connection element 6 and the second housing part 4, a holding force is generated between the second connection element 6 and the second housing part 4.

An adjustment device according to the present disclosure was explained above with reference to an exemplary embodiment in which the first securing element 13 is designed as a securing plate which is fixed by axial clamping between the first connection element 5 and the pretensioning means 7, and the second securing element 20 is designed as a securing disk which is fixed by radial clamping between the second housing part 4 and the second connection element 6. It is understood that the first connection element 5 can also be secured axially to the housing 2 by a first securing element designed as a securing disk and the second connection element 6 can be axially secured to the housing by a second securing element designed as a securing plate, or that the first securing element and the second securing element can both be designed as a securing disk or both as a securing plate.

What is claimed is:

1-18. (canceled)

19. An adjustment device for a pivotable vehicle flap comprising:
a housing, wherein the housing comprises a first housing part and a second housing part;
a pretensioning means arranged in the housing and extending along a longitudinal axis for pretensioning the first housing part relative to the second housing part;
a first connection element arranged at a first end of the housing for connecting to one of the vehicle body and the vehicle flap; and
a second connection element arranged at a second end of the housing for connecting to the other of the vehicle body and the vehicle flap,
wherein a first securing element is arranged between the first connection element and the housing,
wherein the first securing element axially secures the first connection element to the housing, and the first securing element has a securing portion which is coupled to the housing, wherein the securing portion comprises a first securing collar which is at least non-positively connected to an inner side of the housing,
wherein the first securing collar comprises at least two prongs separated by a slot.

20. The adjustment device according to claim 19, wherein the securing portion is configured to be self-securing.

21. The adjustment device according to claim 19, wherein the first securing element has an inner collar which is coupled to the first connection element.

22. The adjustment device according to claim 19, wherein the securing portion can additionally be connected in a positive-locking manner to the inner side of the housing.

23. The adjustment device according to claim 22, wherein the inner side of the housing has a recess in which the securing collar latches.

24. The adjustment device according to claim 19, wherein the first securing collar comprises multiple prongs separated by slots, wherein the multiple prongs are elastically bendable.

25. The adjustment device according to claim 21, wherein the first securing element has an intermediate portion, wherein the intermediate portion is arranged between the inner collar and the securing portion.

26. The adjustment device according to claim 19, wherein the first securing element consists of metal.

27. The adjustment device according to claim 26, wherein the first securing element is a spring steel strip.

28. The adjustment device according to claim 21, wherein the first securing element is a securing plate.

29. The adjustment device according to claim 28, wherein the inner collar of the securing plate has a flat end face.

30. The adjustment device according to claim 21, wherein the first securing element is a securing disk.

31. The adjustment device according to claim 30, wherein the inner collar of the first securing element has multiple prongs separated by slots, wherein the multiple prongs are directed inwards.

32. The adjustment device according claim 19, wherein a second securing element is arranged between the second connection element and the housing, wherein the second securing element axially secures the second connection element to the housing.

33. The adjustment device according to claim 32, wherein the second securing element is a securing plate or a securing disk.

34. The adjustment device according to claim 19, wherein the first connection element is connected to a first end of the pretensioning means, and the second connection element is connected to a second end of the pretensioning means.

35. The adjustment device according to claim 21, wherein the inner collar of the first securing element is fixed in a clamped manner axially between a flat end-face stop surface provided at a first end of the pretensioning means and an end face of the first connection element.

36. The adjustment device according claim 19, wherein the first securing element is fixed in a clamped manner radially between the first connection element and the housing.
